(19) United States
(12) Patent Application Publication
(10) Pub. No.: US 2013/0167012 A1
(43) Pub. Date: Jun. 27, 2013

(54) DYNAMIC WEBSITE BUILDING SYSTEM

(71) Applicant: William Fischer, Orange, CA (US)

(72) Inventor: William Fischer, Orange, CA (US)

(73) Assignee: FISHER PRINTING, INC., Orange, CA (US)

(21) Appl. No.: 13/809,070

(22) PCT Filed: Jul. 8, 2011
(86) PCT No.: PCT/US11/43421

§ 371 Date: Mar. 4, 2013

Related U.S. Application Data
(60) Provisional application No. 61/362,501, filed on Jul. 8, 2010.

(51) Int. Cl. G06F 17/22

(52) U.S. Cl. CPC G06F 17/2247
USPC 715/234

(57) ABSTRACT

A dynamically integrated website that allows for collection of web page templates and themes to be used in the development of an individual or business website is provided. The system allows for use of a plurality of different colors, images, and text within the website development and checks for availability of any particular domain name through a customizable search mechanism. The system also maintains a database having a plurality of image libraries with the ability for the individual user to choose stored images, texts and the like, and the ability to download and/or upload customized text, images, and other data to the system for integration into the website. Moreover, the system may add title tag and metatag information to help search engine keyword searches during development of the website. Additionally, the system may have a online support portion whereby support tickets may be utilized to help individual system users. The system may also utilize an online live chat help mechanism allowing for individualized help in the creation of the customized website.

### PRIORITY CLAIM

This application claims priority to the earlier filed U.S. Provisional Application No. 61/362,501 filed on Jul. 8, 2010, entitled “Dynamic Website Building System.”

### FIELD OF THE INVENTION

The field of the invention is for a website development system. More specifically, in some embodiments, the field of invention is for a dynamic website design and collection system which allows an individual to personalize and develop a website all from an integrated system.

### BACKGROUND

Having a website has become an important aspect in selling goods and services in today's fast paced and competitive marketplace. Having a website that describes the goods and services and gives examples to potential customers of these goods and services can be the difference between a consumer contracting with one vendor and another.

The ability to build, utilize and customize a web page is very important to ongoing business development and advertising of goods and services. Typically these built websites, especially those that allow the individual vendor to build their own website, utilizes templates for designing websites that assist people in quickly designing web pages for publishing to a web hosting server. These pre-programmed and template website building systems offer very limited accessibility and customization. Typically, a user will utilize the building tool to build a standard, nondescript website with very limited ability to customize the website to the user's particular desires.

The alternative to utilizing these build it yourself type websites, is the use of a professional website developer. The professional website developer may give the owner greater flexibility as to what may be included and utilized on the website, but the control of the website, where it will be hosted and the like are all decided upon not by the owner, but rather by the website developer/designer. Additionally, the increased costs of hiring a developer/designer to design the website and then maintain it, can be cost prohibitive for many individual owners and/or small businesses.

One of the challenges in designing web page templates where content may be customized by end users is that the size of the content or amount of text that may be inserted into the editable areas of the web page may vary from user to user. Because a web page generally provides a header area, a navigational area, and a bottom border around editable areas that may be customized by a user, the template design required some knowledge of the size of the editable areas. Previously, this has caused template providers to set a static size editable area, thereby limiting the amount of content that the user can insert in the editable areas.

Another challenge for the designers of web page templates is the desirability of making web page themes work in all types of browsers.

Accordingly, it would be desirable to provide a web page generating tool that has a simple user interface and allows a web page designer to create flexible auto-expanding editable areas which grow and shrink based on the amount of content inserted into the editable areas, and to design themes that work in all browsers.

Therefore, a need exists for an improved website design system that dynamically allows the choice from a collection of web page templates and themes to build a website. Additionally, a need exists for a website design system which allows for a choice of domain name selection, image libraries, linking systems, support response systems and other integrated abilities that are all part of the improved website design system.

### SUMMARY OF THE INVENTION

The present invention relates to a dynamically integrated website that allows for a collection of web page templates and themes to be used in the development of an individual or business website. The system allows for use of a plurality of different colors, images, and text within the website development and checks for availability of any particular domain name through a customizable search mechanism. The system also maintains a database having a plurality of image libraries with the ability for the individual user to choose stored images, texts and the like, and the ability to download and/or upload customized text, images, and other data to the system for integration into the website. Moreover, the system may add title tag and metatag information to help search engine keyword searches during development of the website. Additionally, the system may have a online support portion whereby support tickets may be utilized to help individual system users. The system may also utilize online live chat help mechanism allowing for individualized help in the creation of the customized website.

To this end in an exemplary embodiment, a dynamitic website building system and method is provided.

In an exemplary embodiment, a web page template for customizing a web page in a web building tool, comprising: an auto-expanding user-editable content container having associated therewith an upper horizontal guide and a lower horizontal guide each of which horizontally intersects the auto-expanding user-editable content container; an outer background area; and an inner background.

In another exemplary embodiment, further comprising an auto-expanding navigational area which expands and contracts as navigation buttons are added and removed by an end user.

In another exemplary embodiment, wherein the outer background area comprises only a solid color, a repeated pattern, or a vertical gradient.

In another exemplary embodiment, wherein the inner background comprises only a solid color.

In another exemplary embodiment, wherein the auto-expanding user-editable content container allows only web-safe fonts.

In another exemplary embodiment, comprising at least one text area which can support non-web-safe fonts.

In another exemplary embodiment, wherein a size of text entered in the text area is determined using a Rich Text Editor, the web building tool automatically determining an amount to scale the current sized text to make the text the full width of the available text area, determining an amount to scale the current sized text to make the text the full height of the available text area, selecting the smaller of the horizontal scale and vertical scale, scaling the user-input text by the smaller selected scale, and replacing the user-input text in the text area with the scaled text.

In another exemplary embodiment, an HTML generation tool comprising: a processor; a memory configured to store instructions, the instructions causing the processor to generate an auto-expanding user-editable content container having associated therewith an upper horizontal guide and a lower horizontal guide each of which horizontally intersects the auto-expanding user-editable content container visible to a user at an output device, an outer background area visible to a user at an output device, and an inner background visible to a user at an output device; the instructions further causing the processor to generate HTML code based on user inputs relating to the auto-expanding user-editable content container, the outer background area, and the inner background.

In another exemplary embodiment, comprising a plurality of templates and themes and instructions causing the processor to integrate one or more template or theme into HTML code to build a website.

In another exemplary embodiment, comprising a centralized database including a plurality of colors, images, and text stored in the database for use by the individual user and further comprising instructions causing the processor to process incoming and outgoing information from an individual user and wherein the database includes an upload ability to allow a user to maintain an image library.

In another exemplary embodiment, comprising instructions causing the processor to check for availability of a domain name through a customized search mechanism which is integrated into the tool and instructions allowing an individual user to register a domain name through the system by checking through third party search mechanism and allowing for seamless registration through a third party domain name registrar.

In another exemplary embodiment, comprising a database having a plurality of image, text, audio, video and other media selections to be utilized by the individual website designer and may also allow for the ability to search online through the system for personalized and customized media to be uploaded into the system for the use with building the website.

In another exemplary embodiment, comprising a database with a plurality of digital media including images, text, video, audio and other media whereby the media may be accessed by the user to develop their customized website.

In another exemplary embodiment, further comprising instructions allowing for dynamically adding title tag and meta tag information to the HTML code to help search engine keyword searches.

In another exemplary embodiment, further comprising instructions for dynamic creation of contact pages whereby the website owner may receive emails and other types of communication through the personalized and customized website.

In another exemplary embodiment, comprising an online support mechanism to help individuals in development of their personalized website.

In another exemplary embodiment, wherein the online support mechanism allows a user to create an online support tickets and receive responses from the system to queries by the individual developer.

In another exemplary embodiment, further comprising including instructions for an online live chat system allowing the individual user to query the system for real-time answers to problems and/or questions encountered while developing their customized and personalized website.

In an exemplary embodiment, a computer-readable medium containing a set of instructions that causes a processor to: generate an auto-expanding user-editable content container having associated therewith an upper horizontal guide and a lower horizontal guide each of which horizontally intersects the auto-expanding user-editable content container visible to a user at an output device; generate an outer background area visible to a user at an output device, and an inner background visible to a user at an output device; generate code for a web page based on user inputs relating to the auto-expanding user-editable content container, the outer background area, or the inner background.

In another exemplary embodiment, comprising a collection of web page templates and themes to be used in the development of an individual or business website; a database having a plurality of image libraries with the ability for the individual user to choose stored images, fonts, and the ability to download and/or upload customized fonts, images, and other data to the system for integration into the website.

In an exemplary embodiment, a dynamic website building system and method is provided whereby the system utilizes a plurality of templates and themes to build a website.

In an exemplary embodiment, the dynamic website building system utilizes a plurality of web page templates and themes to build a website.

In an exemplary embodiment, the dynamic website building system and method utilizes a plurality of information in a centralized database including a plurality of colors, images, and text stored in the database for use by the individual user.

In an exemplary embodiment, the dynamic website building system may have a centralized CPU which may process incoming and outgoing information from the individual user.

It is further contemplated that another exemplary embodiment is to provide a website building system whereby the system may check for availability of a domain name through a customized search mechanism which is integrated into the system.

Among the many different possibilities contemplated, the website building system and method allows an individual user to register a domain name through the system by checking through a third party search mechanism and allowing for seamless registration through a third party domain name registrar.

In an exemplary embodiment, a website building system is provided whereby the system may maintain an image library and upload ability to a user to maintain their own image library.

In still another exemplary embodiment, a website building system may be provided whereby the system may have a database having a plurality of image, text, audio, video and other media selections to be utilized by the individual website designer and may also allow for the ability to search online through the system for personalized and customized media to be uploaded into the system for the use with building the website.

In yet another exemplary embodiment, a website building system may be provided whereby the system may have a database with a plurality of digital media including images, text, video, audio and other media whereby the media may be accessed by the user to develop their customized website.

Yet another exemplary embodiment is to provide a website building system whereby the system may allow for dynamically adding title tag and metatag information to help search engine keyword searches.

Still another exemplary embodiment is to provide a website building system whereby the system may allow for dynamic creation of contact pages whereby the website owner may receive emails and other types of communication through the personalized and customized website.

Another exemplary embodiment is to provide a website building system whereby the system may have at least an online support mechanism to help individuals in development of their personalized website.

In another exemplary embodiment, a website building system is provided whereby the system may have at least an online support mechanism which allows the user to create online support tickets and receive responses from the system to queries by the individual developer.

Another exemplary embodiment is to provide a website building system whereby the system may have a online live chat system allowing the individual user to query the system for real-time answers to problems and/or questions encountered while developing their customized and personalized website.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates an embodiment of the system for dynamically integrated website generation system in accordance with an embodiment of the systems and methods described herein.

FIG. 2 illustrates an embodiment of the system for dynamically integrated website generation system in accordance with an embodiment of the systems and methods described herein.

FIG. 3 illustrates an embodiment of a system in an exemplary embodiment of the invention.

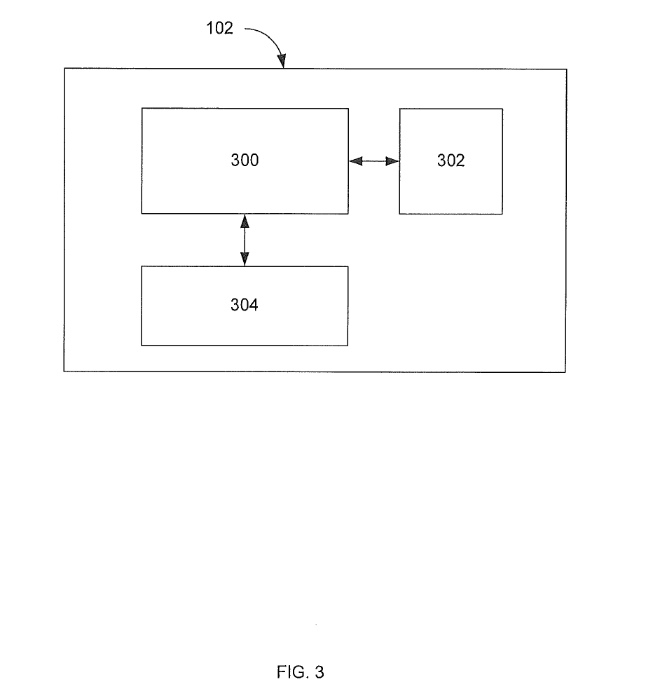

### DETAILED DESCRIPTION OF THE PREFERRED EMBODIMENT

One embodiment of the systems and methods described herein provides a dynamically integrated website generation that allows for collection of web page templates and themes to be used in the development of an individual or business website by generating Hypertext Markup Language (HTML) code. HTML is a markup language that may be used to write web pages.

HTML can include various HTML elements which generally include tags. These tags normally come in pairs and are enclosed in angle brackets within the web page content. The first tag in a pair is the start or open tag, the second tag is the end or closing tag. In between these tags web designers can add text, tables, images, etc. Web browsers can be used to read HTML documents and compose them into visual or audible web pages. Rather than display the HTML tags, the web browser uses the tags to interpret the content of the page. XHTML (eXtensible Hypertext Markup Language) is a family of XML markup languages that mirror or extend versions of the widely-used Hypertext Markup Language (HTML), the language in which web pages are written.

The systems and methods described herein can take user input visual information and generate HTML code, XTML, Cascading Style Sheets (CSS), or other material that can define the appearance and layout of various material, e.g., text. The XHTML, HTML and the CSS are well known standards.

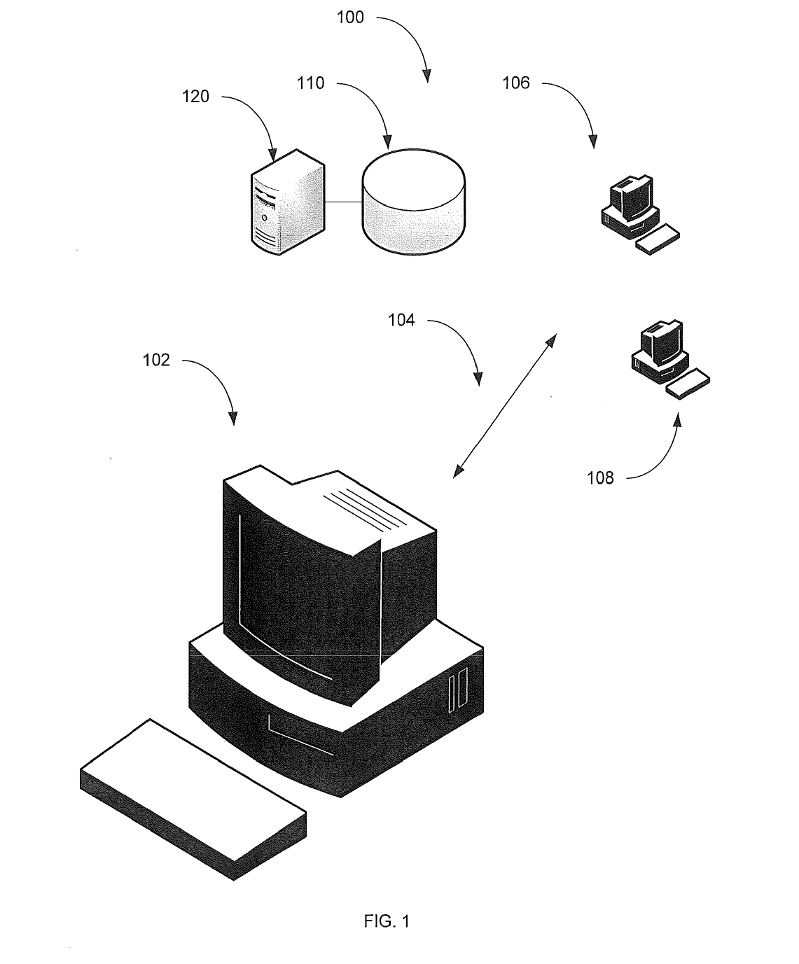

FIG. 1 illustrates an embodiment of a system 100 for dynamically integrated website generation in accordance with an embodiment of the systems and methods described herein. The system 100 allows for a collection of web page templates and themes to be used in the development of an individual or business website and can use a plurality of different colors, images, and text within the website being developed. (The website being developed may generally be viewed on a monitor connected to a computer system 102 implementing aspects of the system 100.) The system 100 may also maintain a database having a plurality of image libraries with the ability for the individual user to choose stored images, texts and the like, and the ability to download and/or upload customized text, images, and other data to the system for integration into the website.

Meta elements, such as a metatag, can include HTML elements that may be used to provide structured metadata about a Web page. Multiple elements may be used on the same page, e.g., the element being the same, but using different attributes. In an embodiment, the system 100 may add title tag and metatag information to help search engine keyword searches during development of the website.

Additionally, in an embodiment, the computer 102 may have an online, e.g., internet connection 104 based support portion whereby support tickets may be utilized to help individual system users. The system 100 may also utilize online 104 live chat help mechanism allowing for individualized help in the creation of the customized website. For example, a technical support person may chat with a person using the system 100 by connecting a computer 102 to a technical support computer 106 over the internet 104.

In an embodiment, the system 100 checks for availability of any particular domain name through a customizable search mechanism. Such a customizable search mechanism might, for example, connect to another computer 108 over the internet 104. That computer might include a database of domain names which can be compared to a desired domain name. In some embodiments, when a searched domain name is already in the database domain similar available domain names can be generated by the computer 108 and transmitted back to the system 100 for review by a user. Additionally, the website building system 100 may allow an individual user to register a domain name through the system by checking through a third party search mechanism and allowing for seamless registration through a third party domain name registrar. It is further contemplated that another exemplary embodiment is to provide a website building system 100 whereby the system 100 may check for availability of a domain name through a customized search mechanism which is integrated into the computer 102. In other words, the check may be performed using information stored at a computer 102 rather than at the database 110 or server 120.

In an exemplary embodiment, the dynamic website building system and method utilizes a plurality of information in a centralized database 110 including a plurality of colors, images, and text stored in the database for use by the individual user. In some embodiments the database might be stored on server 120, connected to server 120, or stored on a network drive. The database may be accessed over the internet 104 or other network or communication channel(s).

The system 100 may maintain an image library and upload ability to user to maintain their own image library. This library may be maintained remotely, e.g., at server 120, at database 110, network storage; or locally, e.g., on a storage device in or directly connected to computer 102. The website building system 100 may have a database having a plurality of image, text, audio, video and other media selections to be utilized by the individual website designer and may also allow for the ability to search online through the system for personalized and customized media to be uploaded into the system for the use with building the website. This database may also be maintained remotely, e.g., at server 120, at database 110, network storage; or locally, e.g., on a storage device in or directly connected to computer 102.

In yet another exemplary embodiment, a website building system 100 may be provided whereby the system may have a database with a plurality of digital media including images, text, video, audio and other media whereby the media may be accessed by the user to develop their customized website. Depending on the location where the database is stored, the user may access this information over a network, e.g., the internet or some other communication channel. If the information is stored at computer 102 the user may access the information locally. Generally, this may be transparent to the user.

Yet another exemplary embodiment is to provide a website building system 100 whereby the system may allow for dynamically adding title tag and metatag information to help search engine keyword searches. This can allow for the search engines to direct searchers to the website and may increase traffic to the website.

In another exemplary embodiment is to provide a website building system whereby the system may allow for dynamic creation of contact pages whereby the website owner may receive emails and other types of communication through the personalized and customized website. The contact page may include, for example, one or more email addresses, with a link to these email addresses and/or one or more postal addresses, telephone numbers, links to the web site owner's social networking information, etc.

Another exemplary embodiment is to provide a website building system whereby the system may have at least an online support mechanism to help individuals in development of their personalized website. For example, the website building system may have at least an online support mechanism which allows the user to create online support tickets and receive responses from the system 100 to queries by the individual developer. The system may have an online live chat system allowing the individual user to query the system for real-time answers to problems and/or questions encountered while developing their customized and personalized website. For example, computer 102 may be connected to computer 108 over, e.g., the internet 104. A user of system 100 can then chat with a technical support person that may be using computer 108.

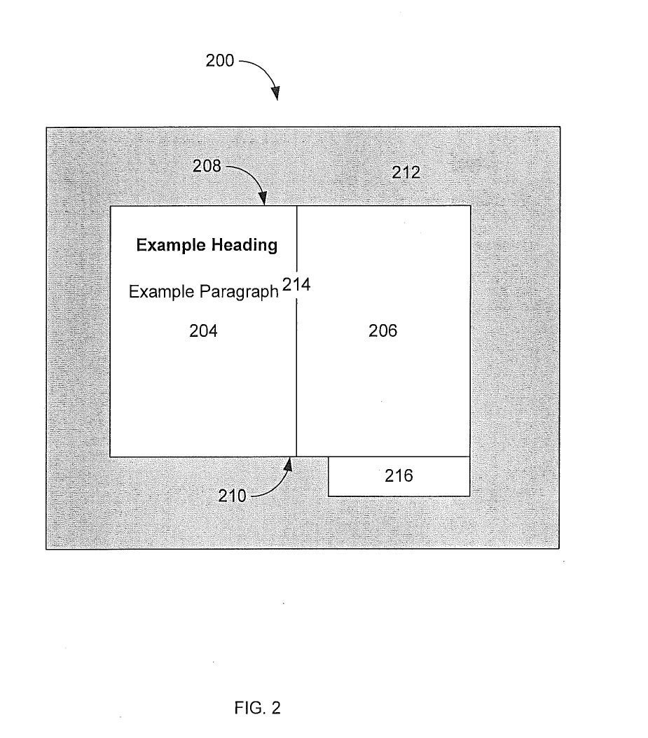

FIG. 2 illustrates example graphical template 200 and themes that may be utilized to build a website. A theme refers to the design of the web page and the organization between the elements. For example, different portions of a webpage may share the same or similar backgrounds, including colors, patterns, etc. The background might be tied in to other aspects of the web page, such as music.

Template 200 can be used to customize a web page in a web building tool. In an exemplary embodiment the template 200 includes an auto-expanding user-editable content container 204, 206 having associated therewith an upper horizontal guide 208 and a lower horizontal guide 210 each of which horizontally intersects the auto-expanding user-editable content container 204, 206. The template 200 can also include an outer background area 212 and an inner background 214. For example, the inner background area 214 may provide background “underneath” text in one or more of the content containers. In an exemplary embodiment, the outer background area 212 may include only a solid color, a repeated pattern, or a vertical gradient. (A solid color, grey, is illustrated.) The inner background area might be only a solid color (e.g., white, as illustrated or another color) or a repeated pattern, or a vertical gradient, etc.

In one exemplary embodiment, the auto-expanding user-editable content container 204 allows only web-safe fonts. In another exemplary embodiment, there will be at least one text area, e.g., user-editable content container 204, 206, which can support non-web-safe fonts. Additionally, in an exemplary embodiment, the web page template 200 includes an auto-expanding navigational area 216 which expands and contracts as navigation buttons are added and removed by an end user. It will also be understood that, while the illustrated embodiment includes two user-editable content container 204, 206 and one auto-expanding navigational area 216 there may be more or fewer of these areas. Additionally the areas of these items illustrated in the figures are just examples.

In one exemplary embodiment, the size of text entered in the text area is determined using a Rich Text Editor. The web building tool can automatically determine an amount to scale the current sized text to make the text the full width of the available text area, determine an amount to scale the current sized text to make the text the full height of the available text area, selecting the smaller of the horizontal scale and vertical scale, scaling the user-input text by the smaller selected scale, and replacing the user-input text in the text area with the scaled text.

A simple HTML example is provided below:

<html>
<body>
<h1>Example Heading</h1>
<p>Example paragraph.</p>
</body>
</html>

On a web browser the example HTML code can be a web page that has a heading “Example Heading” with a paragraph “Example Paragraph” below it. The systems and methods described herein allow a user to graphically develop a webpage and then generate, for example, HTML from that. Accordingly, after generating the document illustrated in FIG. 2 the simple HTML example above may be generated. Other HTML code will also be generated, e.g., for the grey outer background area 212. The white inner background area 214 might be a default, however, HTML code may be generated for other colors, patterns, etc. For example, a user may wish the inner background area 214 to match the outer background area 212, e.g., grey.

Additionally, while the example discussed above relates to the generation of HTML, it will be understood that the systems and methods described herein generally relate to generating a website, regardless of the type of code used. Accordingly, the systems and methods described herein may be applied to generate XHTML, Cascading Style Sheets (CSS) or other known or yet to be developed web page building blocks.

In an exemplary embodiment, the dynamic website building system may have a centralized CPU 300, e.g., in computer 102, which may process incoming and outgoing information from the individual user. The CPU can be a processor, microprocessor, digital logic, or other processing circuitry. Additionally, CPU processor 300 may be attached to a memory 302. The memory may be volatile memory such as random access memory (RAM), including DRAM, SDRAM, SRAM, or other volatile memory types currently being developed or yet to be developed or non-volatile memory such as read only memory (ROM), PROM, EPROM, EEPROM, Flash or other non-volatile memory types currently being developed or yet to be developed. In many systems memory 302 will include a combination of volatile and non-volatile memory.

System 100 may also include other storage devices 304 such as a disk drive, CD-ROM, DVD-ROM that may be used to store, read, or write a computer readable medium or some combination of these functions. The computer readable medium may be used to store instructions for the processor 300 that may be read and executed by the processor 300. For example, the instructions may be read from the computer readable medium and stored in a volatile memory 302. The processor may read the instructions from memory 302 and execute the instructions.

For example, the computer-readable medium may contain a set of instructions that causes a processor to generate an auto-expanding user-editable content container having associated therewith an upper horizontal guide and a lower horizontal guide each of which horizontally intersects the auto-expanding user-editable content container visible to a user at an output device. The instructions can also cause the processor to generate an outer background area visible to a user at an output device, and an inner background area visible to a user at an output device and generate code for a web page based on user inputs relating to the auto-expanding user-editable content container, the outer background area, or the inner background area.

The computer readable medium can also include a collection of web page templates and themes to be used in the development of an individual or business website and a database having a plurality of image libraries with the ability for the individual user to choose stored images, and fonts. Some embodiments can also include an ability to download and/or upload customized fonts, images, and other data to the system for integration into the website.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

What is claimed is:

1. A web page template for customizing a web page in a web building tool, comprising:
an auto-expanding user-editable content container having associated therewith an upper horizontal guide and a lower horizontal guide each of which horizontally intersects the auto-expanding user-editable content container;
an outer background area; and
an inner background area.

2. The web page template of claim 1, further comprising an auto-expanding navigational area which expands and contracts as navigation buttons are added and removed by an end user.

3. The web page template of claim 1, wherein the outer background area comprises only a solid color, a repeated pattern, or a vertical gradient.

4. The web page template of claim 1, wherein the inner background area comprises only a solid color.

5. The web page template of claim 1, wherein the auto-expanding user-editable content container allows only web-safe fonts.

6. The web page template of claim 1, further comprising at least one text area which can support non-web-safe fonts.

7. The web page template of claim 1, wherein a size of text entered in the text area is determined using a Rich Text Editor, the web building tool automatically determines an amount to scale the current sized text to make the text the full width of the available text area, determine an amount to scale the current sized text to make the text the full height of the available text area, selecting the smaller of the horizontal scale and vertical scale, scaling the user-input text by the smaller selected scale, and replacing the user-input text in the text area with the scaled text.

8. An HTML generation tool comprising:
a processor;
a memory configured to store instructions, the instructions causing the processor to generate an auto-expanding user-editable content container having associated therewith an upper horizontal guide and a lower horizontal guide each of which horizontally intersects the auto-expanding user-editable content container visible to a user at an output device, an outer background area visible to a user at an output device, and an inner background area visible to a user at an output device;
the instructions further causing the processor to generate HTML code based on user inputs relating to the auto-expanding user-editable content container, the outer background area, and the inner background area.

9. The HTML generation tool of claim 8, further comprising a plurality of templates and themes and instructions causing the processor to integrate one or more templates or themes into HTML code to build a website.

10. The HTML generation tool of claim 8, further comprising a centralized database including a plurality of colors, images, and text stored in the database for use by the individual user and further comprising instructions causing the processor to process incoming and outgoing information from an individual user and wherein the database includes an upload ability to allow a user to maintain an image library.

11. The HTML generation tool of claim 8, further comprising instructions causing the processor to check for availability of a domain name through a customized search mechanism which is integrated into the tool and instructions allowing an individual user to register a domain name through the system by checking through a third party search mechanism and allowing for seamless registration through a third party domain name registrar.

12. The HTML generation tool of claim 8, further comprising a database having a plurality of image, text, audio, video and other media selections to be utilized by the individual website designer and may also allow for the ability to search online through the system for personalized and customized media to be uploaded into the system for the use with building the website.

13. The HTML generation tool of claim 8, further comprising a database with a plurality of digital media including images, text, video, audio and other media whereby the media may be accessed by the user to develop their customized website.

14. The HTML generation tool of claim 8, further comprising including instructions allowing for dynamically adding title tag and metatag information to the HTML code to help search engine keyword searches.

15. The HTML generation tool of claim 8, further comprising instructions for dynamic creation of contact pages whereby the website owner may receive emails and other types of communication through the personalized and customized website.

16. The HTML generation tool of claim 8, further comprising an online support mechanism to help individuals in development of their personalized website.

17. The HTML generation tool of claim 16, wherein the online support mechanism allows a user to create online support tickets and receive responses from the system to queries by the individual developer.

18. The HTML generation tool of claim 8, further comprising including instructions for an online live chat system allowing the individual user to query the system for real-time answers to problems and/or questions encountered while developing their customized and personalized website.

19. A computer-readable medium containing a set of instructions that causes a processor to:
generate an auto-expanding user-editable content container having associated therewith an upper horizontal guide and a lower horizontal guide each of which horizontally intersects the auto-expanding user-editable content container visible to a user at an output device;
generate an outer background area visible to a user at an output device, and an inner background area visible to a user at an output device;
generate code for a web page based on user inputs relating to the auto-expanding user-editable content container, the outer background area, or the inner background area.

20. The computer readable medium of claim 19, further comprising a collection of web page templates and themes to be used in the development of an individual or business website; a database having a plurality of image libraries with the ability for the individual user to choose stored images, fonts, and the ability to download and/or upload customized fonts, images, and other data to the system for integration into the website.
